(19) United States
(12) Patent Application Publication
(10) Pub. No.: US 2005/0283460 A1
(43) Pub. Date: Dec. 22, 2005

(54) Database apply-managing system, database apply-managing method and recording medium

(75) Inventor: Arthur Chen, Shindian City (TW)

Correspondence Address: BIRCH STEWART KOLASCH & BIRCH, PO BOX 747, FALLS CHURCH, VA, 22040-0747, US

(73) Assignee: VIA Technologies, Inc.

(21) Appl. No.: 11/132,229

(22) Filed: May 19, 2005

(30) Foreign Application Priority Data
Jun. 16, 2004 (TW) 093117257

(51) Int. Cl. G06F 7/00

(52) U.S. Cl. 707/1

(57) ABSTRACT

A database apply-managing system comprises at least one database, and a database access module, which transforms specific data into general format data and accesses the general format data in the database and further stores the general format data to another database. In addition, a database apply-managing method and recording medium, which records a computer-readable database apply-managing program, are provided.

### BACKGROUND OF THE INVENTION

1. Field of Invention

The invention relates to a database apply-managing system and a database apply-managing method, and, in particular, to a database apply-managing system and a database apply-managing method, which can be applied in cross databases.

2. Related Art

Recently, the electrical information industries are greatly developed, and various operation systems are accordingly invented. As a result, different program languages and application programs are continuously developed.

As mentioned above, the electrical database is one of the most wide spread application programs. The most popular electrical databases are, for example, the MS-SQL database (presented by Microsoft Corporation) and Oracle database (presented by Oracle Corporation). Since the different electrical databases are designed by different companies, they usually provide different functions and have different data storage formats and storing methods. Although each electrical database advertises its powerful functions, the integration of different electrical databases is difficult. Thus, the data exchange between the different electrical databases cannot be performed efficiently, resulting in inconvenience of users.

For example, when a manufacturer wants to manufacture an electrical product, three subjects must be concerned. Firstly, the manufacturer must have the right of using a database, which can be purchased for a complete usage or an authorized usage. Secondly, the manufacturer must work on the research of manufacturing the hardware of the product according to the demands of the product. Finally, a suitable interface program must be invented for the database and the hardware, so as to perform the access of the database, such as inputting and storing the information received by the hardware into the database, or retrieving the information stored in the database for displaying on the hardware.

With reference to FIG. 1, the manufacturer gains the using right of a first database 11 so as to manufacture the required hardware 20. Then, the first interface program 31 corresponding to the first database 11 and the hardware 20 is developed for communicating the first database 11 and the hardware 20. Herein, the first database 11 can be an MS-SQL database or an Oracle database, and the hardware 20 can be a portable electronic device with specific functions, such as a PDA, a GPS navigating system, and the likes. Since the first interface program 31 is developed for the first database 11, it cannot be used to access different type of database, which is familiar as the cross-databases usage. In other words, if the first database 11 is an MS-SQL database, the first interface program 31 may not be used for an Oracle database; otherwise, if the first database 11 is an Oracle database, the first interface program 31 may not be used for an MS-SQL database.

In this case, if the hardware 20 has to cooperate with another database such as a second database 12, which is incompatible with the first database 11, a second interface program 32 must be additionally developed for communicating the second database 12 and the hardware 20. According to the above-mentioned procedures, the first database 11 and the second database 12 can be integrated. Other electrical device cooperating with the hardware 20 might be manufactured by different manufacturers or by different departments of the same manufacturer. In such cases, to integrate information stored in different databases, the manufacturer(s) must develop different interface programs for different databases. Furthermore, if the databases are provided by different companies, the manufacturer(s) must develop the corresponding interface programs for these databases. This may extend the developing period of products, and also increase the producing cost. The previously mentioned problem is caused for cross-database applications. For instance, Java program language is used to develop application programs for the cross-browser usage. However, there is no effective solution for the cross-database usage so far.

Therefore, it is an important subject to provide a database apply-managing system and a database apply-managing method, which can access electrical databases of different types (cross-database function), so as to integrate the stored information.

### SUMMARY OF THE INVENTION

In view of the foregoing, the invention is to provide a database apply-managing system and a database apply-managing method, which can access electrical databases of different types (cross-database function).

In one aspect of the invention, a database apply-managing system of the invention comprises at least one database, and a database access module. The database access module transforms specific data into general format data and accesses the general format data in the database.

In another aspect of the invention, a database apply-managing method of the invention comprises the steps of: providing at least one database, transforming specific data into general format data, and accessing the general format data in the database.

In yet another aspect of the invention, a recording medium of the invention records a computer readable database apply-managing program. The database apply-managing program is for the computer to perform the above-mentioned database apply-managing method of the invention.

As mentioned above, the specific data are transformed into the same format, the general format, which can be supported by different databases, so that the data can be stored in the databases of different types in the general format. Accordingly, the database apply-managing system and method can access the electrical databases of different types. As this manner, the solution for the cross-database usage is carried out, so as to integrate the information stored in the electrical database of different types.

### BRIEF DESCRIPTION OF THE DRAWINGS

The invention will become more fully understood from the detailed description given herein below illustration only, and thus is not limitative of the present invention, and wherein:

FIG. 1 is a schematic view showing the conventional database applying system, which includes hardware, at least one interface program and at least one database;

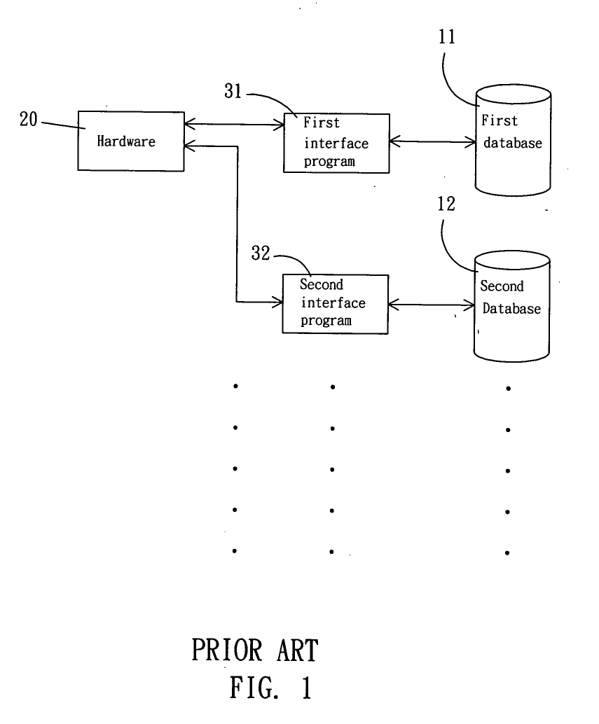

FIG. 2 is a schematic view showing a database apply-managing system according to a preferred embodiment of the invention;

FIG. 3 is a flow chart showing a database apply-managing method according to a preferred embodiment of the invention; and

FIG. 4 is a flow chart showing the details of a step S03 of the database apply-managing method according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

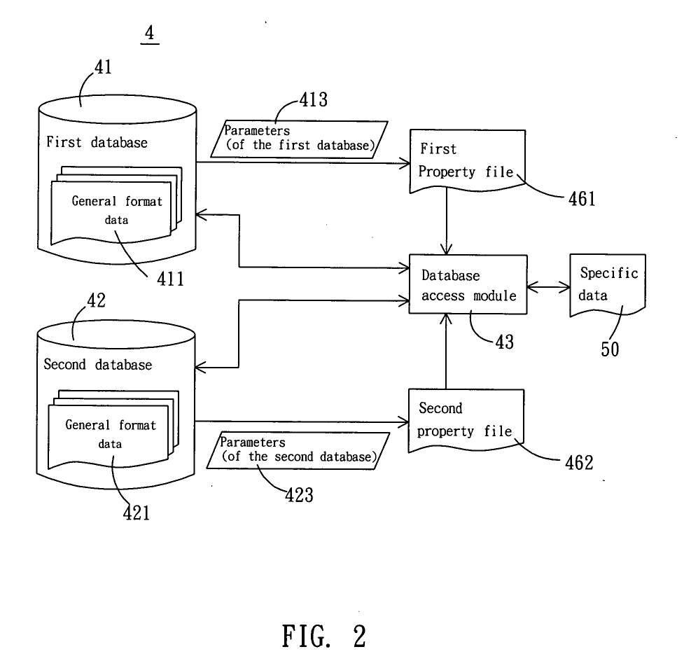

With reference to FIG. 2, a database apply-managing system 4 according to an embodiment of the invention comprises a first database 41, a second database 42, and a database access module 43. In the embodiment, the first database 41 and the second database 42 store a plurality of general format data, which have a general format. In more details, the first database 41 stores the general format data 411, the second database 42 stores the general format data 421, and the formats of the general format data 411 and general format data 421 are both the general format. The database access module 43 transforms specific data 50 into the general format data 411 or the general format data 421. The database access module 43 further accesses the first database 41 to retrieve the general format data 411, and then stores the retrieved general format data 411 into the second database 42. In addition, the database access module 43 can access the second database 42 to retrieve the general format data 421, and then stores the retrieved general format data 421 into the first database 41. If necessary, the database access module 43 can transform the specific data, which are not in the general format, such as the excel file format or access file format outputted from other software, into the general format data, and then stores the transformed data into the first database 41. Alternatively, the database access module 43 can access the second database 42 to retrieve the general format data 421, and then transform the retrieved general format data 421 into the data, which are not in the general format such as the specific data 50.

In the embodiment, the general format can be supported by the first database 41 and the second database 42. For example, the general format can be the format that most databases support, such as a string format or a number format. In the present embodiment, every data, such as a username, ID number and the likes, stored in the first database 41 and second database 42 is set in the general format. The database access module 43 then retrieves the general format data and returns the general format data into the original format thereof, such as a date format, an article format, a figure format, and the likes.

The database apply-managing system 4 further comprises a first property file 461 and a second property file 462, which store parameters 413 of the first database 41 and parameters 423 of the second database 42, respectively. The parameters may at least include a user ID parameter, and a password parameter. The database access module 43 accesses the first database 41 according to the parameters 413 and the first property file 461, and accesses the second database 42 according to the parameters 423 and the second property file 462. For example, the database access module 43 retrieves at least one specific data from the first database 41 according to the first property file 461, transforms the specific data into a general format data, and then stores the general format data into the second database 42 according the second property file 462. Herein, the database access module 43 may create a second specific column in a second database, which is the same as a first specific column in the first database for storing at least one specific data, and then store the general format data into the second specific column of the second database 42.

Besides, the first database 41 and the second database 42 can be used only for storing the general format data 411 and the general format data 421, which are in the general format, and do not provide any calculation. In other words, when accessing the general format data 411 and general format data 421 from the first database 41 and second database 42, the special calculating functions, such as the Foreign Key, equation calculation, relative linking and the likes, that the databases 41 and 42 provide are not utilized. In this embodiment, the relative calculation is performed by other program module, such as the database access module 43. This feature of the invention can prevent the data with the same contents from being stored in different databases with different formats, such as specific data formats, which caused by the specific calculating functions of different databases in the conventional art. Regarding to the conventional art, the formats of the data stored in the different databases must be transformed before the cross-database access. In this embodiment, each database has a MVC (Model-View-Controller) structure, and any language relative to the database is gathered in a data object.

In the present embodiment, the first property file 461 and the second property file 462, which respectively store the parameters 413 and the parameters 423, are both text files and, in particular, are both separable against other data of the corresponding databases. Thus, when changing the database(s), only the corresponding property file(s) should be modified and the data stored in the database(s) are unnecessary to be changed. For example, if the employed database is an MS-SQL database (the first database 41), the corresponding parameters, such as a user ID parameter, password parameter, and other specific instructions relating to the MS-SQL database, are generated and are stored in a property file. Therefore, the database access module 43 can access the general format data from the MS-SQL database according to the property file. Then, if another database of different type, such as an Oracle database (the second database 42), is added, the corresponding parameters, such as a user ID parameter, password parameter, and other specific instructions relating to the Oracle database, are generated and are stored in another property file (the second property file). Accordingly, the database access module 43 can access the general format data from the MS-SQL database according to the property file corresponding to the MS-SQL database, and access the general format data from the Oracle database according to the property file corresponding to the Oracle database.

Moreover, the database apply-managing system 4 can cooperate with two or more databases at the same time. Since each database is only for storing data without providing calculations, the data stored in one database can be transferred between all of the databases at will. Furthermore, the flowing of the data between the databases would not limited by the different calculating instructions of the different databases. Accordingly, the cheaper database or the freeware database can be employed in the invention, so that it is unnecessary to utilize and purchase the professional commercial database with powerful calculating functions, resulting in great decrease of cost. In the current embodiment, the manufacturer only has to develop new program(s) stored in the database access module 43 or other relative component out of the database to process the corresponding calculating instructions.

The database access module 43 may access each database according to a standard language, and each database may process the general format data according to the standard language, such as the standard language certificated by ANSI (American National Standards Institute). Thus, the limitation caused by the different database languages utilized by different databases can be overcome, so as to provide the desired cross-database system.

To be noted, the database apply-managing system 4 could be implemented in an electronic apparatus, such as a conventional computer that comprises a central processing unit (CPU), a storage device, an input device and an output device. The CPU could be in any conventional architecture, such as including an arithmetic logic unit (ALU), a register and a controller, for performing various kinds of operations and to control the operations of other devices in the electronic apparatus. The storage device could be anyone or the combination of computer-readable data storage devices, such as a hard disc drive, an optical disc drive, a dynamic random access memory (DRAM), an electrically erasable programmable read-only memory (EEPROM), or the combinations thereof. The input device could be any device that allows a user to input data or instructions to the electronic apparatus, such as a keyboard, a mouse, or a USB interface. The output device could be a display device or a USB interface.

The modules of the present embodiment could be software modules stored in the storage device. The CPU accesses the software modules, and realizes the functions of the modules through the devices in the electronic apparatus, such as the input device, the storage device, the output device or other software modules. However, it should be noted that persons having ordinary skill in the art may design firmware or hardware, such as an application-specific integrated circuit (ASIC), to realize the function of the software modules mentioned above without departing from the spirit and the scope of the invention. Furthermore, the first database 41 or the second database 42 of the database apply-managing system 4 could be any computer-accessible database, such as an electronic database (the previous-mentioned MS-SQL database or Oracle database) stored in the storage device mentioned above.

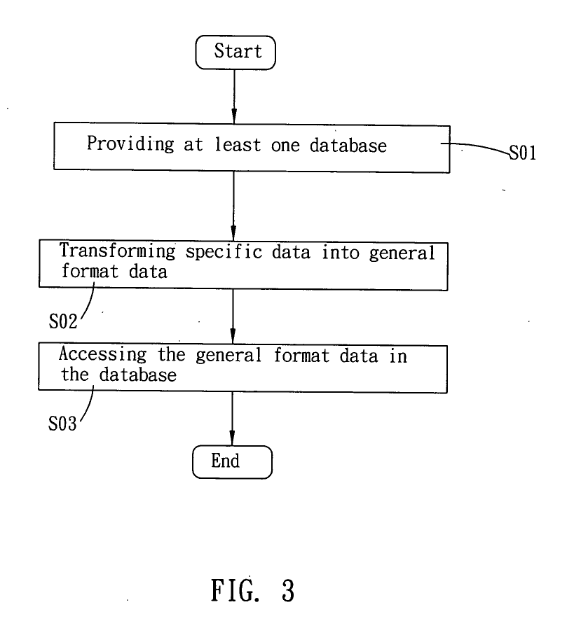

As shown in FIG. 3, the present invention also discloses a database apply-managing method, which comprises the steps of: providing at least one database (step S01), transforming specific data into general format data (step S02), and accessing the general format data in the database (step S03).

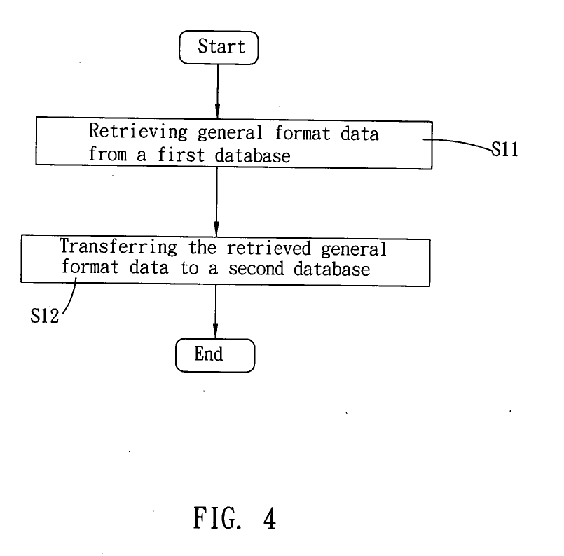

To make the invention more comprehensive, an example of the step S03 of the database apply-managing method with utilizing the database apply-managing system 4, which cooperates with at least one database, according to the embodiment of the invention will be described herein below with reference to FIG. 4.

First, in a step S11, general format data are retrieved from a first database. In the embodiment, the step S11 retrieves the general format data, such as the previously mentioned general format (e.g. a string format) that most databases can support.

In step S12, the retrieved general format data are transferred to a second database. In this embodiment, the step S12 is performed in cross-database accessing, so as to store the general format data retrieved from the first database to the second database. Since the accessed general format data are in the general format, the general format data can be transferred to the second database smoothly. Herein, the steps S11 and S12 are to access the first database according to parameters of the first database recorded in a first property file and to access the second database according to parameters of the second database recorded in a second property file.

As mentioned above, to achieve the purpose of cross-database between the databases of different types, the parameters of the first and second databases recorded in the first and second property files can be text files. Thus, when changing the database(s), only the corresponding property file(s) should be modified, and the changes of the property file corresponding to the changes of database are easy.

In addition, the database apply-managing method may cooperate with two or more databases at the same time.

Since each database is only for storing data without providing calculations such as the special calculating functions including the Foreign Key, equation calculation, relative linking and the likes, the data stored in one database can be transferred between all of the databases at will. For example, if one database utilizes a method A to perform a calculation X and another database utilizes a method B to perform the calculation X or even does not provide the calculation X, the conventional art has a problem on data transferring between the database of different types, but the invention, however, can solve this problem.

In the present embodiment, the databases access process, especially for the cross-database access process, is carried out according to a standard language. The standard language, for example, is that certificated by ANSI (American National Standards Institute).

Since the invention can be implemented by software modules, a recording medium (such as a compact disc, a floppy disc, or a swappable hard disc drive) can be used to record a database apply-managing program comprising these software modules. Thus, a computer may access the recording medium to execute the database apply-managing program, so as to carry out the database apply-managing method mentioned above. The database apply-managing program comprises a plurality of program segments, which correspond to the functions mentioned in the above embodiments.

In summary, the database apply-managing system and method employ different databases only for storing data, which are in the general format such as the string format, number format and the likes. Thus, even the employed databases are in different types such as the MS-SQL database and the Oracle database, the stored data in the general format can be supported by all databases. Accordingly, the database apply-managing system and method can access the electrical databases of different types. As this manner, the solution for the cross-database usage is carried out, so as to integrate the information stored in the electrical database of different types.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A database apply-managing system, comprising:
at least one database; and
a database access module, which transforms specific data into general format data and accesses the general format data in the database.

2. The system of claim 1, wherein the database access module further retrieves the general format data from the database and then stores the general format data into another database.

3. The system of claim 1, wherein the general format data has a general format supported by plural kinds of databases.

4. The system of claim 1, wherein the general format data has a general format, and the general format is at least one selected from the group consisting of a string format and a number format.

5. The system of claim 1, wherein the database processes the general format data stored in the database according to a standard language.

6. The system of claim 1, wherein the database comprises a property file storing parameters of the database.

7. The system of claim 6, wherein the parameters stored in the property file at least comprises a user ID parameter and a password parameter.

8. The system of claim 6, wherein the property file is a text file.

9. The system of claim 6, wherein the database access module accesses a first database to retrieve the specific data according to a first property file of the first database, transforms the specific data into the general format data, and then accesses a second database to store the general format data into the second database according to a second property file of the second database.

10. The system of claim 9, wherein the database access module creates a second specific column in the second database, the second specific column is the same as a first specific column in the first database for storing the specific data, and the database access module then stores the general format data into the second specific column of the second database.

11. The system of claim 1, wherein the database access module retrieves the specific data from another database, transforms the specific data into the general format data, and then stores the general format data to the database.

12. A database apply-managing method, comprising:
providing at least one database;
transforming specific data into general format data; and
accessing the general format data in the database.

13. The method of claim 12, further comprising:
retrieving the general format data from the database; and
storing the general format data into another database.

14. The method of claim 12, wherein the general format data has a general format, and the general format is supported by plural kinds of databases and is at least one selected from the group consisting of a string format and a number format.

15. The method of claim 12, wherein the database comprises a property file storing parameters of the database.

16. The method of claim 15, wherein the parameters stored in the property file at least comprises a user ID parameter and a password parameter.

17. The method of claim 15, wherein the property file is a text file.

18. The method of claim 15, wherein the step of providing at least one database comprises providing a first database and a second database, and the step of accessing the general format data in the database comprises:
accessing the first database to retrieve the specific data according to a first property file of the first database, and
accessing the second database to store the general format data into the second database according to a second property file of the second database.

19. The method of claim 18, wherein the step of accessing the second database to store the general format data into the second database according to the second property file of the second database comprises:
creating a second specific column in the second database, wherein the second specific column is the same as a first specific column in the first database for storing the specific data; and
storing the general format data into the second specific column of the second database.

20. The method of claim 12, wherein the step of accessing the general format data stored in the database comprises:
retrieving the specific data from another database;
transforming the specific data into the general format data; and
storing the general format data to the database.

21. A recording medium, which records a computer readable database apply-managing program, the program comprising:
a connecting program segment for the computer to connect to at least one database; and
a database access program segment for the computer to transform specific data into general format data, and to access the general format data in the database.
